(19) United States
(12) Patent Application Publication
(10) Pub. No.: US 2003/0134625 A1
(43) Pub. Date: Jul. 17, 2003

(54) Method and system for storing mobile phone backup data through a network

(76) Inventor: Jun-Min Choi, Gyeonggi-do (KR)

Correspondence Address: MORGAN & FINNEGAN, L.L.P., 345 Park Avenue, New York, NY, 10154-0053, US

(21) Appl. No.: 10/317,951

(22) Filed: Dec. 12, 2002

(30) Foreign Application Priority Data
Dec. 14, 2001 (KR) 2001-79218

(51) Int. Cl. H04M 3/00

(52) U.S. Cl. 455/418; 455/419

(57) ABSTRACT

The present invention relates to a data backup method on a network and a system embodying such method where a mobile phone in accordance with the present invention includes a memory part which stores data to be backed up as well as programs configured to transmit and retrieve the backup data via wireless circuits; a control part configured to process a user request for a data backup operation and transmit or receive the backup data; and a wireless circuit part configured to convert the backup data processed by the control part into radio signals and transmit the same, or convert the received radio signals into data recognizable by the mobile phone, allowing a user of the mobile phone to easily backup data and retrieve the same.

### BACKGROUND OF THE INVNETION

1. Field of the Invention

The present invention relates to a method and system for storing mobile phone backup data through a network, in particular, to a method and system for storing data of a mobile phone at a specific location via a network as backup data and retrieving the stored data from the specific location.

2. Description of the Prior Art

A mobile phone comprises a memory device in which programs and data are stored capable of performing various functions for a user of the mobile phone. Mobile phones of recent days tend to comprise a high capacity memory in an effort to accommodate more programs and data to provide various services to the users, while the total weight of a mobile phone is reduced for easy carriage. Under these circumstances, the problem of storing of programs and data of a mobile phone has emerged to an important issue. Conventional solutions of such problem includes methods for exchanging data between mobile phones, or between a mobile phone and a computer using, for example, an infrared communication or a wired data communication.

However, the conventional methods are inconvenient in that they require various additional devices for storing the programs and data of a mobile phone. For example, a receiving computer needs to be equipped with an infrared communication port to be compatible with the radio infrared communication. Although such communication would be possible via a serial port without using an infrared function, the data backup process is a complicated process. Moreover, it is not an easy task for a user of a mobile phone to backup the programs and data while he is traveling. In case of an infrared communication between mobile phones, it is not always easy to store data because data stored in a sending side mobile phone may be mixed with the data on the receiver side mobile phone.

### SUMMARY OF THE INVENTION

The present invention, conceived to solve the aforementioned problems, aims to provide a method and system which enable a user of a mobile phone to backup programs and data stored in the mobile phone at a remote server via a network and to retrieve the stored programs and data conveniently. An exemplary method includes: providing a first menu screen for selecting a data backup operation; receiving a first selection request for the data backup operation; and transmitting selected data to the data backup server thereby allowing the selected data to be stored at the data backup server.

In accordance with another aspect of the present invention, there is provided a method and system which enable a user of the mobile phone to retrieve the secured programs and data. An exemplary method includes: providing a first menu screen for selecting a data retrieving operation; receiving a first selection request for the data retrieving operation; and receiving selected data from the data backup server at the mobile phone via the communication network thereby allowing the selected data to be used at the mobile phone.

Other and further aspects of the present invention will become apparent during the course of the following detailed description and by reference to the attached drawings.

### BRIEF DESCRIPTION OF THE DRAWINGS

FIG. 1 is a block diagram showing the internal construction of a mobile phone in accordance with an illustrative embodiment of the present invention;

FIG. 2 is a diagram showing a network construction for backup of data by a mobile phone in accordance with one embodiment of the present invention;

FIG. 3 is a flow chart illustrating the backup process of data stored in a mobile phone at a network in accordance with one embodiment of the present invention;

FIG. 4a is an exemplary screen of a mobile phone for selecting data to be stored as a backup in accordance with the present invention;

FIG. 4b is an exemplary screen of a mobile phone showing the current status of the storing process of selected data via a network; and

FIG. 5 shows an exemplary screen of a mobile phone for implementing data backup of the present invention via a wired network.

### DESCRIPTION OF THE PREFERRED EMBODIMENTS

A description of the preferred embodiments of the present invention is given below making reference to the accompanying drawings.

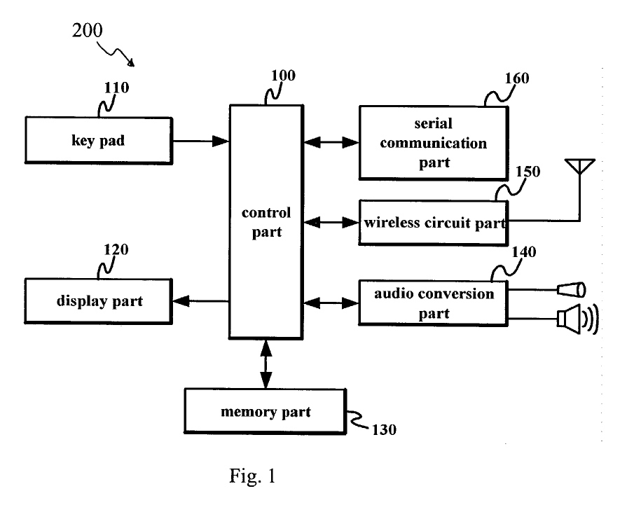

FIG. 1 is a block diagram showing the internal construction of a mobile phone 200 in accordance with the present invention.

The construction block diagram of a mobile phone 200 embodying the present invention comprises a control part 100, a keypad 110, a display part 120, a memory part 130, an audio conversion part 140, a wireless circuit part 150, and a serial communication part 160.

Control part 100 of the mobile phone, being responsible for general controlling of the mobile phone, organizes the overall backup process of the present invention such as transmitting of stored data via a network to a remote location for storing the data and retrieving the secured data from the remote location via the network.

Keypad 110 of the mobile phone, being an interface between the mobile phone and the user of the mobile phone, is input means for a user and includes buttons such as function buttons for inputting of specific functions and general buttons for inputting of letters or figures configured to transmit the user's selection to the mobile phone.

Display part 120 of the mobile phone provides a screen to display various information and options to the user thereby enabling the user to perform a backup operation of the present invention in accordance with the control of the control part of the mobile phone. The screen may display a menu with options to select, status information of the backup process, and other input information entered by the user.

Memory part 130 of the mobile phone stores programs and data for performing various functions processed by the control part of the mobile phone. In particular, the memory part stores programs and data of the algorithms for implementing the functions of the present invention.

Audio conversion part 140 performs a conversion of the user's voice signal recorded through the microphone of the mobile phone using a signal processing method such as digital signal processing (DSP). The audio conversion part also performs a conversion of the signal received from another user and outputs an analog voice signal through the speaker after processing the received data.

Wireless circuit part 150 in cooperation with audio conversion part 140 sends and receives voice and data wirelessly to and from a base station.

Serial communication part 160 performs transmission or reception of data while it is connected to an apparatus such as a notebook computer or a PC via a serial cable supporting serial communication.

The operation of mobile phone 200 in a network according to an illustrative embodiment of the present invention is described herein below.

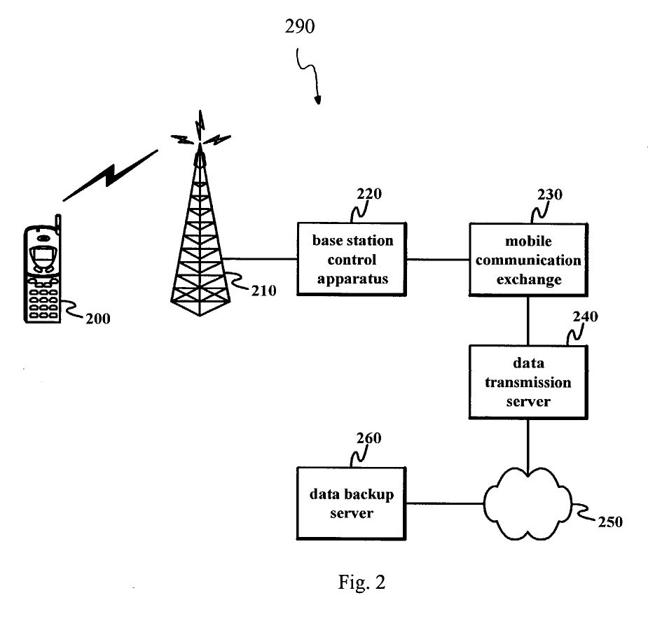

FIG. 2 is an exemplary network construction for backup of data by a mobile phone according to the present invention.

An exemplary network 290 embodying the present invention comprises a mobile phone 200, a base station 210, a base station control apparatus 220, a mobile communication exchange 230, a data transmission server 240, a communication network 250, and a data backup server 260.

Upon initiating the backup process of the present invention, mobile phone 200, being equipped with functions as described in FIG. 1 and related descriptions, transmits a signal including data to be stored at data backup server 260 to base station 210 of the area after converting the signal into a radio signal. The user of the mobile phone usually initiates the transmission in this embodiment. However, the mobile phone may be configured to automatically transmit the signal when a predetermined condition is met.

Base station 210, by establishing a radio connection with mobile phone 200, receives the signal from the mobile phone.

Base station control apparatus 220 connected to base station 210 on site forwards the received signal to a mobile communication exchange 230 through a control apparatus matching process of the mobile communication exchange.

Mobile communication exchange 230 which connects calls by switching operations may forward the signal (i.e., a call) from mobile phone 200 received from base station control apparatus 220 to other exchange if the mobile phone is not registered with the mobile communication exchange, or forward the call to a local exchange if the call is internal. The mobile communication exchange may be configured to bill the call by call duration.

Data transmission server 240 upon receiving request from mobile communication exchange 230, transmits the received signal including backup data to data backup server 260 via communication network 250. The communication network may include the mobile phone service providers' network and/or a wired network such as the public switched telephone network (PSTN).

Data backup server 260 upon receiving the signal with backup data from data transmission server 240, stores the backup data transmitted from mobile phone 200.

The stored backup data at the data backup server according to the process described above may be retrieved at the mobile phone. For example, the user of the mobile phone may initiate a retrieving process by transmitting a request signal to the data backup server via the intermediate communication path as described above (e.g., base station 210, base station control apparatus 220, mobile communication exchange 230, data transmission server 240, network 250). Upon receiving the retrieving request from the mobile phone, the data backup server returns the stored backup data to the mobile phone via the intermediate communication path.

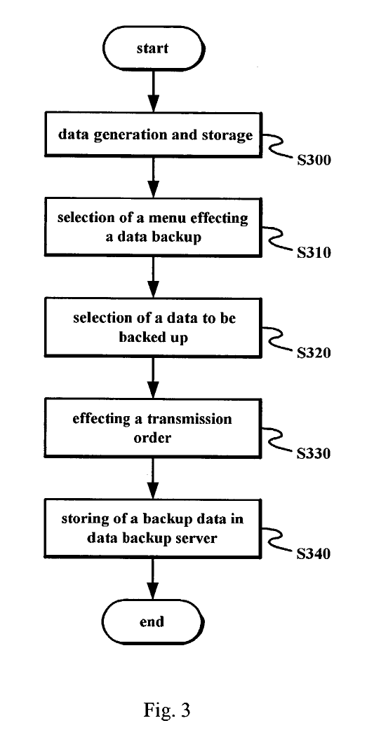

FIG. 3 is a flow chart illustrating the backup process of a data stored in a mobile phone at a network in accordance with one embodiment of the present invention.

A user of a mobile phone stores data (e.g., names of persons, telephone numbers, telephone address book for administration of personal information such as e-mail addresses, pictures, photos, and melodies, etc) once such data have been generated (S300). In addition to data provided by the mobile phone, such data may be generated by the user using the mobile phone. A telephone address book for administration of personal information is an example of data generated by using the key buttons of a keypad of the mobile phone, while the melody is data stored after it has been received from a melody provider or another device. The mobile phone stores the data after the data have been generated at step S300.

For performing a data backup using the mobile phone, the mobile phone may be configured to provide a menu screen for initiating the backup process. Although the present embodiment is described above assuming that the data backup process is embodied as a menu screen, selection of the data backup may be made in various manners. For example, a special key button reserved for such function may be provided by or in the keypad of the mobile phone. If a special key button for a data backup is provided, the user may initiate the backup process by simply pushing the appropriate key button. It is also possible that the data backup process is constructed in such a way that it appears as a simplified icon on the initial screen.

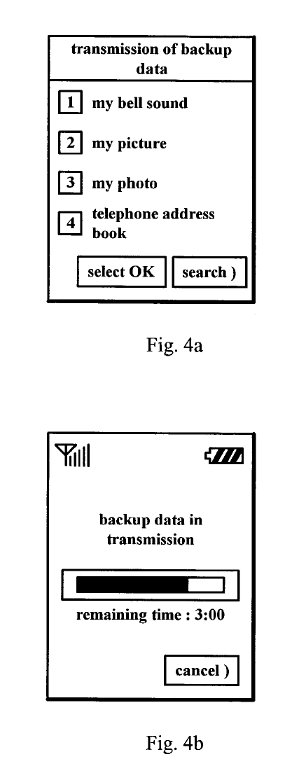

The user initiates the data backup by selecting the data backup process from the menu screen (S310). In response to the selection by the user at step S310, the mobile phone is configured to provide another menu screen for selecting data to be backed up. The user may select one of the options displayed on the menu screen. FIG. 4a shows an exemplary menu screen showing four options to be selected. Data generated by the user such as “my bell sound”, “my picture”, “my photo”, “my telephone address book” are displayed as items to be selected as backup data. The user selects with the menu screen the data to be transmitted as backup data (S320) and thereby effects a transmission order for the selected data (S330). Then, the control part of the mobile phone establishes a communication channel and transmits the backup data to the data backup server. The data backup server then stores the transmitted backup data (S340). During this transmission, a message showing the progress of the transmission may be displayed on the screen of the mobile phone such as shown in FIG. 4b showing the progress of the transmission and the remaining time and so on.

The backup data thus stored may be retrieved from the data backup server any time when the user of the mobile phone requests. For example, if the user selects a backup data fetching function from the menu screen, the backup data is returned from the data backup server to the mobile phone following a similar communication path to that illustrated in FIG. 3.

Using a mobile phone equipped to provide functionality according to the method of the present invention, a user of the mobile phone is able to secure/backup data or retrieve the same with ease, regardless of time and space, using his mobile phone, even when the data are lost due to a mistake of the user or a malfunction of the mobile phone.

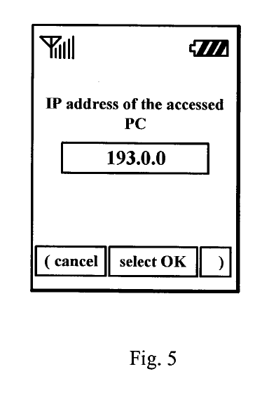

FIG. 5 shows an exemplary screen for implementing data backup via a wired network instead of wireless communication as an alternative embodiment of the present invention.

When neither a cable nor an infrared data communication (e.g., IrDA) is available, data maybe backed up via a wired network using, for example, a modem of a computer or an IP address along with a specific program supporting them. The method with a computer modem utilizes an air data manager program, which supports modem connection as well as data transmission. The mobile phone may be configured to provide a function for a “call to a modem for transmitting” and “a call to a modem for receiving” which may be selected for respectively transmitting and receiving the backup data. Subsequently, the number of the modem to be connected may be inputted by the user of the mobile phone using the keyboard of the mobile phone. Alternatively, the backup process may be performed using a public IP address of a PC connected to a network using the air data manager program. FIG. 5 shows an exemplary screen of the mobile phone configured to provide a data backup function using an IP address of a PC. A user of the mobile phone establishes a connection to a computer by inputting the IP address of the computer connected to the mobile phone via a network. Backup data maybe stored or retrieved between the mobile phone and PC using the IP address of the PC along with a supporting program such as air data manager.

Although the present invention has been described above referring to the preferred embodiments and the accompanying drawings, it should be noted that the present invention is not limited thereto, but rather, the scope of rights of the present invention shall be determined in accordance with the appended claims, allowing various adaptations, modifications, and alterations without departing the scope and spirit of the present invention as those skilled in the art will understand.

What is claimed is:

1. A method for securing data of a mobile phone in a data backup server connected to the mobile phone via a communication network comprising:
providing a first menu screen with operation selection;
selecting a data backup operation;
receiving a first selection request for the data backup operation; and
transmitting selected data to the data backup server thereby allowing the selected data to be stored at the data backup server.

2. The method according to claim 1 further comprising providing a second menu screen for selecting data to be backed up.

3. The method according to claim 1 further comprising receiving a second selection request for the data to be backed up.

4. The method according to claim 1 further comprising establishing a communication channel to the data backup server.

5. The method according to claim 1 wherein the communication network includes a wireless network.

6. The method according to claim 1 wherein the communication network includes a wired network.

7. The method according to claim 1 further comprising:
transmitting the backup data stored in the data backup server to the mobile phone via the communication network, upon receiving a request by the mobile phone; and
storing the transmitted data from the data backup server at a memory part of the mobile phone.

8. The method according to claim 1, wherein the backup data includes either one of telephone address books, pictures, photos or melodies.

9. A method for retrieving data stored at a data backup server by a mobile phone, wherein the data backup server and the mobile phone are connected through a communication network, the method comprising:
providing a first menu screen with operation selection;
selecting a data retrieving operation;
receiving a first selection request for the data retrieving operation; and
receiving selected data from the data backup server at the mobile phone via the communication network thereby allowing the selected data to be used at the mobile phone.

10. The method according to claim 9 further comprising providing a second menu screen for selecting data to be retrieved.

11. The method according to claim 9 further comprising receiving a second selection request for the data to be retrieved.

12. The method according to claim 9 further comprising establishing a communication channel between the mobile phone and the data backup server.

13. The method according to claim 9 wherein the communication network includes a wireless network.

14. The method according to claim 9 wherein the communication network includes a wired network.

15. A mobile phone comprising:
a memory which stores program for transmitting data of the mobile phone to be backed up to a data backup server via a wireless circuit and for retrieving the backed up data from the data back up server;
a control part configured to control the transmission of the data to the data backup server or the reception of the data from the data backup server in accordance with a request from a user of the mobile phone; and
a transmission circuit configured to transmit the data to the data backup server processed by the control part after converting the data into radio signals, or convert radio signals received from the data backup server into data recognizable by the mobile phone, thereby enabling the user to easily backup and use the data after retrieving the data from the data backup server.

16. The mobile phone of claim 15, wherein the transmission circuit is wireless.

17. The mobile phone of claim 15, wherein the transmission circuit is a wired network.
